(19) United States
(12) Patent Application Publication
(10) Pub. No.: US 2023/0198073 A1
(43) Pub. Date: Jun. 22, 2023

(54) BATTERY PACK AND DEVICE INCLUDING THE SAME

(71) Applicant: LG Energy Solution, Ltd., Seoul (KR)

(72) Inventor: Chan Kyu Lee, Daejeon (KR)

(21) Appl. No.: 17/924,922

(22) PCT Filed: Oct. 8, 2021
(86) PCT No.: PCT/KR2021/013919

§ 371 Date: Nov. 11, 2022

(30) Foreign Application Priority Data
Oct. 23, 2020 (KR) 10-2020-0138422

(51) Int. Cl. H01M 50/264; H01M 50/211

(52) U.S. Cl. CPC H01M 50/264; H01M 50/211

(57) ABSTRACT

A battery pack and a device including the same are provided. The battery pack includes a battery module and a battery pack frame on which the battery module is mounted, the battery module comprising a battery cell stack in which a plurality of battery cells are stacked, a module frame accommodating the battery cell stack, and end plates covering front and rear sides of the battery cell stack, and a fastening member coupling the module frame to the battery pack frame.

### CROSS REFERENCE TO RELATED APPLICATION(S)

This application is a National Stage Application of International Application No. PCT/KR2021/013919, filed on Oct. 8, 2021, which claims priority to and the benefit of Korean Patent Application No. 10-2020-0138422 filed on Oct. 23, 2020, the disclosures of which are incorporated herein by reference in their entirety.

### FIELD

The present disclosure relates to a battery pack and a device including the same. More particularly, the present disclosure relates to a battery pack in which an internal space of a battery module can be effectively utilized, and a device including the same.

### BACKGROUND

Rechargeable batteries are receiving a lot of attention as energy sources in various product groups such as mobile devices and electric vehicles. As a powerful energy resource that can replace the use of existing products that use fossil fuels, rechargeable batteries are spotlighted as an environmentally-friendly energy source because they do not generate by-products from energy use.

Recently, as the need for a large capacity rechargeable battery structure and the use of a rechargeable battery as an energy storage source is increased, the demand for a battery pack with a multi-module structure in which a plurality of rechargeable batteries are assembled in series/coupled in parallel battery modules is increasing.

Meanwhile, when a battery pack is configured by coupling a plurality of battery cells in series or in parallel, in general, a battery module including at least one battery cell is formed and then other constituent elements are added using a plurality of battery modules to add other constituent elements to the battery.

The battery module forming such a battery pack includes a battery cell stack in which a plurality of battery cells are stacked, a frame accommodating the battery cell stack, and end plates covering front and rear surfaces of the battery cell stack respectively.

FIG. 1 shows a figure in which a conventional battery module is mounted in a battery pack frame. FIG. 2A is a cross-sectional view taken along the line A-A′ of FIG. 1, and FIG. 2B shows the end plate 30 of FIG. 1.

Referring to FIG. 1, FIG. 2A, and FIG. 2B, which show a comparative example, conventionally, the battery module and the battery pack are combined by combining the battery pack frame 40 and the end plate 30 with a bolt/nut using hollow mounting holes 31 formed on both ends of the end plate 30 formed on the front and rear surfaces of the frame 20 of the battery module.

However, as shown in FIG. 2A, there is a problem that a space utilization efficiency inside the battery module deteriorates due to the volume of a part where the mounting hole 31 is disposed, and a cell terrace 11a inside the battery module has to be bent in the direction where the mounting hole 31 is not disposed. That is, as shown in FIG. 2B, the mounting hole 31 is formed in the space inside the end plate 30, and thus the cell terrace 11a must be turned in the direction where the mounting hole 31 is not disposed so as to not interfere with it. Such a bent installation of cell terrace 11a may cause a problem in terms of stability of the battery module, and there is a problem that an additional process is required to break the cell terrace 11a.

In addition, as shown in the part B of FIG. 2A, due to the volume of the part where the mounting hole 31 is disposed, electrode leads 11b are folded in only one direction on a bus bar 12 surface, and thus there is a problem in that welding of the electrode lead 11b can only be done in a single direction.

### SUMMARY

The problem to be solved by the present disclosure is to provide a battery pack that can efficiently utilize an internal space of a battery module and a device including the same.

The problems of the present disclosure are not limited to the problems mentioned above, and other problems not mentioned will be clearly understood by a person of an ordinary skill in the art from the description below.

A battery pack according to an embodiment of the present disclosure for implementing the solution includes a battery module and a battery pack frame on which the battery module is mounted, and the battery module includes a battery cell stack in which a plurality of battery cells are stacked, a module frame accommodating the battery cell stack, end plates covering front and rear sides of the battery cell stack, and a fastening member coupling the module frame to the battery pack frame.

The end plate does not comprise a mounting hole for coupling the end plate to the battery pack frame.

The fastening member may include a pack hook protruding toward the module frame from the battery pack frame and a module hook protruding corresponding to the pack hook from a side surface of the module frame.

The pack hook and the module hook may extend along a length direction of the side surface of the module frame, and the pack hook may include a recess portion into which the module hook is inserted, and the module hook may be coupled to the pack hook by sliding along the recess portion.

The module hook may include a protrusion portion that extends toward the recess portion from an end protruding in a direction that is parallel with a bottom surface of the battery pack frame from the side surface of the module frame.

The fastening member may include a first welding line that is formed in a portion where the side surface of the module frame and the battery pack frame are in contact with each other.

The fastening member may further include a second welding line formed in a portion where the end plate and the battery pack frame are in contact with each other.

The fastening member may include at least one strap that surrounds an outer side of the module frame and at least one welding point that fastens an end of the at least one strap to the battery pack frame.

The at least one strap may include a first strap that surrounds the side surface and an upper surface of the module frame and a second strap that intersects a length direction of the battery module and surrounds the upper surface of the module frame and the end plate.

A device according to another embodiment of the present disclosure includes the battery pack.

A battery pack according to an embodiment of the present disclosure and a device including the same can increase the space efficiency inside the battery module by removing the volume occupied by the conventional mounting hole structure, and can simplify the manufacturing process of the battery module by removing the unnecessary cell terrace folding process.

The effects of the present disclosure are not limited to the effects mentioned above, and other effects not mentioned will be clearly understood by a person of an ordinary skill in the art from the description of the claimed range.

### BRIEF DESCRIPTION OF DRAWINGS

FIG. 1 shows a figure in which a conventional battery module is mounted in a battery pack frame.

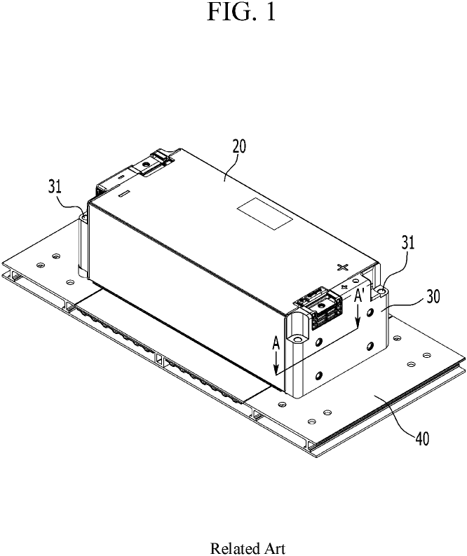

FIG. 2A is a cross-sectional view taken along the line A-A′ of FIG. 1.

FIG. 2B shows the end plate 30 of FIG. 1.

FIG. 3 shows a battery pack according to an embodiment of the present disclosure.

FIG. 4 is an enlarged view of a cross-section of the portion C in FIG. 3.

FIG. 5A is a cross-sectional view of an internal figure of the battery module according to the embodiment of the present disclosure, taken along the line D-D′ of FIG. 3.

FIG. 5B shows an inner side of the end plate of FIG. 3.

FIG. 6 shows a battery pack according to another embodiment of the present disclosure.

FIG. 7 shows a battery pack according to another embodiment of the present disclosure.

### DETAILED DESCRIPTION

Hereinafter, with reference to the accompanying drawings, various embodiments of the present disclosure will be described in detail such that those of ordinary skill in the art can easily carry out the present disclosure. The present disclosure may be implemented in several different forms and is not limited to the embodiments described herein.

The drawings and description are to be regarded as illustrative in nature and not restrictive. Like reference numerals designate like elements throughout the specification.

In the drawings, size and thickness of each element are arbitrarily illustrated for convenience of description, and the present disclosure is not necessarily limited to as illustrated in the drawings. In the drawings, the thickness of layers, films, panels, regions, etc., are exaggerated for clarity. In addition, the drawing, for convenience of explanation, the thickness of some layers and regions is exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, throughout the specification, the word “on” a target element will be understood to be positioned above or below the target element, and will not necessarily be understood to be positioned “at an upper side” based on an opposite to gravity direction.

In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

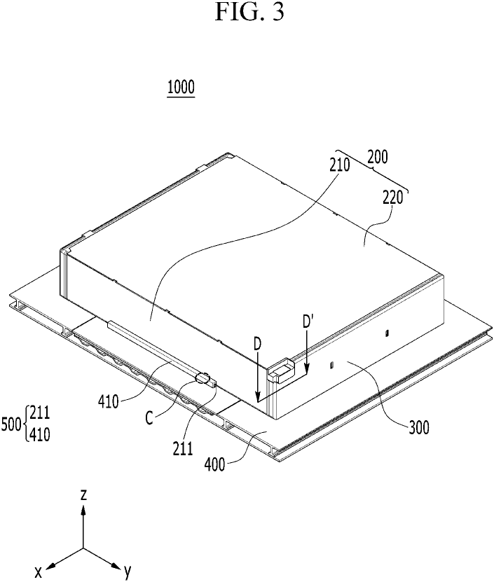

Hereinafter, a coupling structure between a battery module and a battery pack frame in a battery pack according to an embodiment will be described with reference to FIG. 3 to FIG. 5.

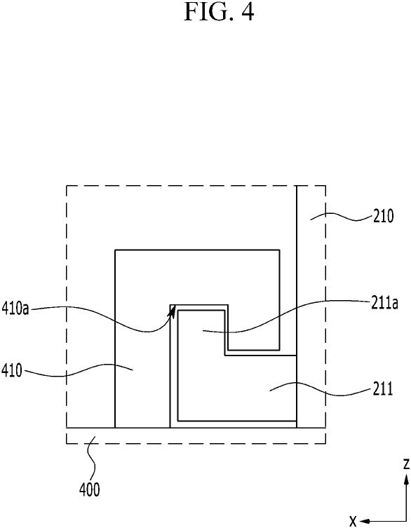

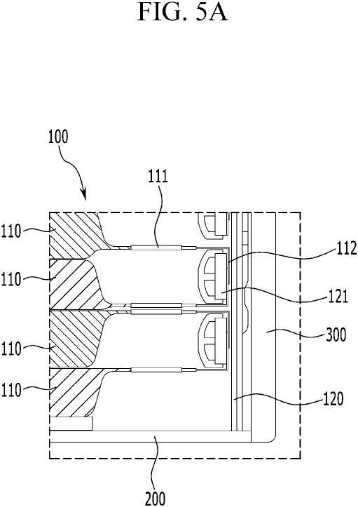

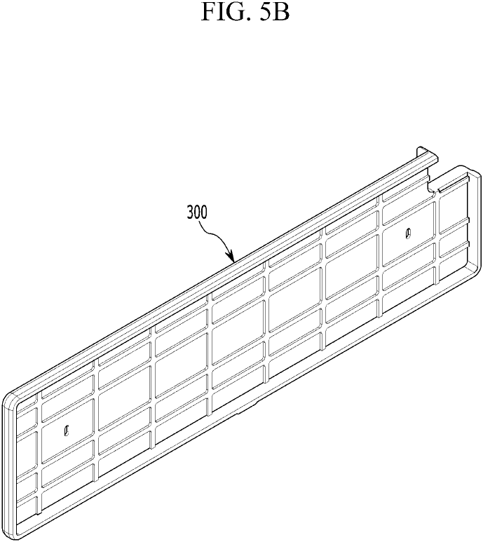

FIG. 3 shows a battery pack according to an embodiment of the present disclosure. FIG. 4 is an enlarged view of a cross-section of the portion C in FIG. 3. FIG. 5A is a cross-sectional view of an internal figure of the battery module according to the embodiment of the present disclosure, which is the part D-D′ of FIG. 3. FIG. 5B shows an inner side of the end plate of FIG. 3.

Referring to FIG. 3 to FIG. 5B, a battery pack 1000 according to an embodiment of the present disclosure includes a battery module and a battery pack frame 400 to which the battery module is installed. Here, the battery module includes a battery cell stack 100 in which a plurality of battery cells are stacked, a module frame 200 that accommodates the battery cell stack 100, and an end plate 300 that covers front and rear sides of the battery cell stack 100. In addition, the battery module includes a fastening member 500 that couples the module frame 200 and the battery pack frame 400.

The module frame 200 accommodates the battery cell stack 100 and physically protects the battery cell stack 100. According to the embodiment of the present disclosure, the module frame 200 is formed in upper, lower, left, and right surfaces to cover the upper, lower, left, and right surfaces of the battery cell stack 100. In this case, the module frame 200 may have a rectangular tube shape in which top, bottom, left, and right surfaces are continuously connected, or it may have a form in which the upper surface is combined on a U-shaped frame in which the lower surface and left and right surfaces are connected, but this is not restrictive. In FIG. 3, the module frame 200 of the form in which the upper plate 220 is combined on the side surface 210 extending vertically from the lower surface is exemplarily described, but this configuration as well is not limited to the above said configuration, and may be appropriately applied as long as the module frame 200 covers the top, bottom, left, and right surfaces of the battery cell stack 100.

The end plate 300 is formed on the front and rear surfaces of the battery cell stack 100 respectively to cover the front and rear surfaces of the battery cell stack 100. Electrical connection between the battery cell stack 100 and the outside can be blocked through the end plate 300.

Referring to FIG. 5A, the battery cell 110 is a rechargeable battery and may be configured as a pouch-type rechargeable battery. The battery cells 110 may be provided in a plurality, and a plurality of battery cells 110 may be stacked to each other so as to be electrically connected to each other to form the battery cell stack 100.

Each of the plurality of battery cells may include an electrode assembly, a cell case, and an electrode lead 112 protruding from the electrode assembly.

The electrode assembly may be formed of a positive electrode plate, a negative electrode plate, and a separator. The cell case is for packaging the electrode assembly, and may be formed of a laminate sheet including a resin layer and a metal layer. Such a cell case may include a case body and a cell terrace 111.

The cell terrace 111 extends from the case body and is sealed to seal the electrode assembly. The electrode lead 112 may be partially protruding from one side of this cell terrace 111.

The electrode lead 112 may be electrically connected to the electrode assembly. The electrode leads 112 may be provided as a pair. A portion of the pair of electrode leads 112 may be protruding outside the cell terrace 111 from the front and rear of the cell case, respectively.

The bus bar frame 120 may be formed to cover the front and rear surfaces of the battery cell stack 100. The bus bar 121 may be formed on the outer surface of the bus bar frame 120. The electrode leads 112 extending from the cell terrace 111 may pass through a lead slot of the bus bar frame 120 and a slot of the bus bar 121, and then be coupled to the outer surface of the bus bar 121 in a folded state by welding. Through this, the battery cells 110 and the bus bars 121 can be electrically connected.

In the present embodiment, since a fastening member 500 that couples the module frame 200 and the battery pack frame 400 is included to fix the battery module to the battery pack frame 400, a hole for mounting on the end plate 300 is not included. That is, as shown in FIG. 5B, a portion protruding to form a hole inside the end plate 300 is not included.

Conventionally, the end plate and the battery pack frame are coupled to each other by a method in which mounting holes are formed at both ends of the end plate, the mounting hole is connected to the battery pack frame, and a bolt is inserted into the mounting hole. However, in this case, when the battery module is coupled to the battery pack through the mounting hole, there is a problem in that it becomes difficult to utilize a space inside the battery module as much as the volume occupied by the mounting hole.

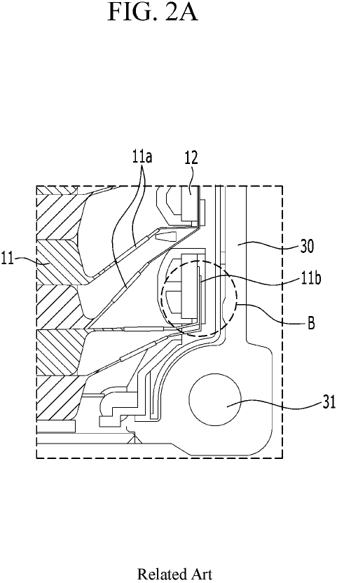

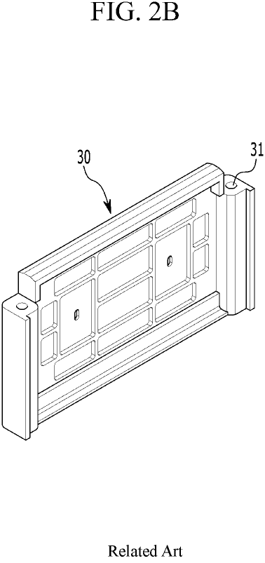

More specifically, as a comparative example shown in FIG. 2A, the cell terrace 11a inside the battery module must be installed with the mounting hole 31 bent in the opposite direction to avoid a portion where the mounting hole 31 is formed, and the electrode leads 11b protrude from the outermost battery cells among the battery cells need to be folded in the opposite direction to the direction in which the mounting hole 31 is installed so as to contact the bus bars 12 formed in the portion where the mounting hole 31 is not positioned.

However, according to the embodiment of the present disclosure, as shown in FIG. 5A, the mounting hole is not formed in the end plate 300 and thus the space occupied by the conventional mounting hole can be utilized.

In addition, according to the embodiment of the present disclosure, as shown in FIG. 5A, the bus bar 121 may be positioned in the space previously occupied by the mounting hole. Therefore, the cell terrace 111 does not need to be bent and installed, and can be installed in a state extending from the battery cells 110 in a straight line, and thus there is no longer a need for a separate step of bending the cell terrace 111, which can contribute to reducing the manufacturing process and simplifying the process. In addition, the edge of the cell terrace 111 had to be removed at an angle to avoid interference with the mounting hole, but, in the embodiment of the present disclosure, since the space occupied by the mounting hole is empty, there is no need to remove the edge of the cell terrace 111, which further simplifies the manufacturing process.

In addition, the bus bar 121 can be positioned in a position corresponding to the electrode leads 112 of the battery cells 110 in the outer portion, and thus the electrode leads 112 formed in the outer portion can be folded in both directions on the outer surface of the bus bar 121. Accordingly, both parts of the electrode lead 112 can be welded and the weldability between the electrode lead 112 and the bus bar 121 can be strengthened.

In the present embodiment, instead of the mounting hole, as shown in FIG. 3 and FIG. 4, as a fastening member 500, a pack hook 410 protruding toward the module frame 200 from the battery pack frame 400 and a module hook 211 protruding corresponding to the pack hook 410 from the side surface 210 of the module frame 200 are included. That is, the module frame 200 can be fixed to battery pack frame 400 by combining pack hook 410 and module hook 211.

Specifically, referring to FIG. 4, the pack hook 410 is vertically protruding from the battery pack frame 400 toward the top, extends toward the side surface 210 of the module frame 200, and then the end extends to face downward again such that a recess portion 410a into which the module hook 211 is inserted can be formed. That is, the recess portion 410a opened toward the bottom of the z-axis direction in drawing is formed. In addition, as shown in FIG. 3, the entire shape of the pack hook 410 extends along the length direction (y-axis direction in the drawing) of the side surface 210 of the module frame 200.

The module hook 211 is slidably coupled to the recess portion 410a of the pack hook 410. That is, the module hook 211 includes a protrusion portion 211a that protrudes from the side surface 210 of the module frame 200 in a direction parallel to the bottom surface of the battery pack frame 400 (x-axis direction of drawing) and then the end of the protrusion portion 211a is extended to the top (i.e., upper z-axis direction of drawing), and the battery module may be fixed to the battery pack frame 400 by sliding the protrude portion 211a to engage the recess portion 410a of the pack hook 410.

As described, the battery module can be firmly fixed to the battery pack frame 400 without a mounting hole in the end plate 300 by coupling the pack hook 410 and the module hook 211,

In particular, since the battery module is fixed by slidingly combining the pack hook 410 and the module hook 211 in a fixed position, the battery module can be accurately coupled without a position error.

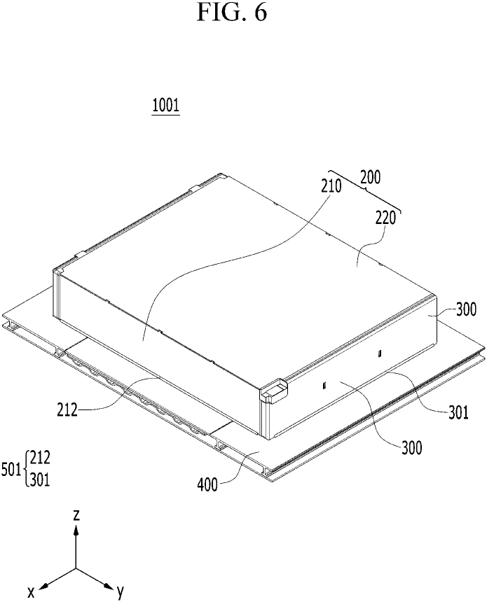

Hereinafter, referring to FIG. 6, a combination structure between a battery module and a battery pack frame according to another embodiment of the present disclosure will be described.

FIG. 6 shows a battery pack according to another embodiment of the present disclosure.

Referring to FIG. 6, a battery pack 1001 according to another embodiment of the present disclosure may include a first welding line 212 and a second welding line 301 as a fastening member 501.

That is, in the present embodiment, as a countermeasure with respect to removing a mounting hole of an end plate 300, a module frame 200 and a battery pack frame 400 are connected by welding. For this purpose, a first welding line 212 welded along a line where a side surface 210 of the module frame 200 and the battery pack frame 400 contact. In addition, it further includes a second welding line 301 that is welded along a line where an end plate 300 and the battery pack frame 400 are in contact with each other for more robust fixation.

According to this, although there is no mounting hole, the battery module can be firmly fixed to the battery pack frame 400, and thus as described in the previous embodiment, the manufacturing process of the battery module can be simplified and the electrode leads can be disposed more stably by using an added space by removing the mounting hole inside the battery module.

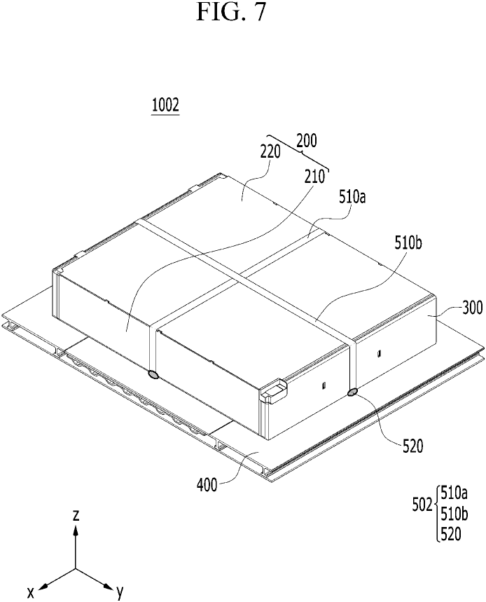

FIG. 7 shows a battery pack according to another embodiment of the present disclosure.

Referring to FIG. 7, a battery pack 1002 according to another embodiment of the present disclosure may include a first strap 510a, a second strap 510b, and a welding point 520 as a fastening member 502.

That is, in the present embodiment, instead of removing the mounting hole of the end plate 300, a battery module can be fixed to a battery pack frame 400 by wrapping the battery module with the first and second straps 510a and 510b and wrapping the first and second straps 510a and 510b with the welding point. For this purpose, the first strap 510a that wraps a side surface 210 and an upper surface 220 of the module frame 200 is included. In addition, for more robust fixation, the second strap 510b that surrounds the upper surface 220 and the end plate 300 of the module frame 200 and intersects the first strap 510a on the upper surface 220 of the module frame 200 is further included.

The first and second straps 510a and 510b may have a metal thin strap shape. Ends of the first and second straps 510a and 510b may be fixed by welding. That is, the ends of the first and second straps 510a and 510b may be firmly fixed to the battery pack frame 400 by the welding points 520 fixed to the battery pack frame 400 by welding.

According to this, although there is no mounting hole, the battery module can be firmly fixed to the battery pack frame 400, and thus as described in the previous embodiment, the manufacturing process of the battery module can be simplified and the electrode leads can be disposed more stably by using an added space by removing the mounting hole inside the battery module.

The battery pack according to the embodiments of the present disclosure may have a structure in which a battery management system (BMS) and a cooling device are added to manage the temperature or voltage of the battery and the like.

The battery pack can be applied to various devices. Such a device may be applied to transportation means such as an electric bicycle, an electric vehicle, a hybrid vehicle, and the like, but the present disclosure is not limited thereto and is applicable to various devices that can use a battery module, which is also within the scope of the present disclosure.

In the above, a preferred embodiment of the present disclosure has been shown and described, but the present disclosure is not limited to the specific embodiment described above, and numerous variations can be implemented by a person of ordinary skill in the technical field to which the disclosure belongs without departing from the gist of the present disclosure claimed in the claimed range, and these variant implementations are not to be construed in isolation from the spirit or prospects of the present disclosure.

Description of Reference Numerals
100: battery cell stack
110: battery cell
111: cell terrace
112: electrode lead
120: bus bar frame
121: bus bar
200: module frame
300: end plate
400: battery pack frame
500, 501, 502: fastening member
211: module hook
410: pack hook
212: first welding line
301: second welding line
510a: first strap
510b: second strap
520: welding point
1000, 1001, 1002: battery pack

1. A battery pack including a battery module and a battery pack frame on which the battery module is mounted, the battery module comprising:
a battery cell stack in which a plurality of battery cells are stacked;
a module frame accommodating the battery cell stack;
end plates covering front side and rear side of the battery cell stack respectively; and
a fastening member coupling the module frame to the battery pack frame.

2. The battery pack of claim 1, wherein the end plate does not comprise a mounting hole for coupling the end plate to the battery pack frame .

3. The battery pack of claim 1, wherein the fastening member comprises a pack hook protruding toward the module frame from the battery pack frame and a module hook protruding corresponding to the pack hook from a side surface of the module frame.

4. The battery pack of claim 3, wherein the pack hook and the module hook extend along a length direction of the side surface of the module frame, and
wherein the pack hook comprises a recess portion into which the module hook is inserted, and
wherein the module hook is coupled to the pack hook by sliding along the recess portion.

5. The battery pack of claim 4, wherein the module hook comprises a protrusion portion that extends toward the recess portion from an end protruding in a direction that is parallel with a bottom surface of the battery pack frame from the side surface of the module frame.

6. The battery pack of claim 1, wherein the fastening member comprises a first welding line that is formed in a portion where a side surface of the module frame and the battery pack frame are in contact with each other.

7. The battery pack of claim 6, wherein the fastening member further comprises a second welding line formed in a portion where the end plate and the battery pack frame are in contact with each other.

8. The battery pack of claim 1, wherein the fastening member comprises at least one strap that surrounds an outer side of the module frame and at least one welding point that fastens an end of the at least one strap to the battery pack frame.

9. The battery pack of claim 8, wherein the at least one strap comprises a first strap that surrounds a side surface and an upper surface of the module frame and a second strap that intersects a length direction of the battery module and surrounds the upper surface of the module frame and the end plate .

10. A device comprising the battery pack of claim 1.
